(19) United States
(12) Patent Application Publication
(10) Pub. No.: US 2023/0281680 A1
(43) Pub. Date: Sep. 7, 2023

(54) SYSTEM AND METHODS FOR RESOURCE ALLOCATION

(71) Applicant: ADOBE INC., SAN JOSE, CA (US)

(72) Inventors: Michail Mamakos, Chicago, IL (US); Sridhar Mahadevan, Morgan Hill, CA (US); Viswanathan Swaminathan, Saratoga, CA (US); Mariette Philippe Souppe, Pleasanton, CA (US); Ritwik Sinha, Cupertino, CA (US); Saayan Mitra, San Jose, CA (US); Zhao Song, Seattle, WA (US)

(21) Appl. No.: 17/652,939

(22) Filed: Mar. 1, 2022

(51) Int. Cl. G06Q 30/02; G06Q 10/06; G06F 9/50

(52) U.S. Cl. CPC G06Q 30/0283; G06Q 10/06313; G06F 9/5033

(57) ABSTRACT

Systems and methods for resource allocation are described. The systems and methods include receiving utilization data for computing resources shared by a plurality of users, updating a pricing agent using a reinforcement learning model based on the utilization data, identifying resource pricing information using the pricing agent, and allocating the computing resources to the plurality of users based on the resource pricing information.

### BACKGROUND

The following relates generally to computer networking, and more specifically to resource allocation.

A computer network may include a set of computing devices that operate as network nodes using shared resources, such as computing power, storage, bandwidth, energy, etc. Resource allocation is a task in computer networking that determines how many of the shared resources should be provided to each network node.

However, a computer network may not efficiently allocate the shared resources. For example, a node may be provided with a predetermined number of resources regardless of current need, leaving those resources idle when they could be employed elsewhere. Additionally, when the resources are allocated to nodes in exchange for payment, a node that has been charged for the use of idle resources may not be aware that it is incurring costs.

### SUMMARY

A method for resource allocation is described. One or more aspects of the method include receiving utilization data for computing resources shared by a plurality of users; updating a pricing agent using a reinforcement learning model based on the utilization data; identifying resource pricing information using the pricing agent; and allocating the computing resources to the plurality of users based on the resource pricing information.

A method for resource allocation is described. One or more aspects of the method include receiving utilization data for computing resources shared by a plurality of users; identifying resource pricing information using a pricing agent based on the utilization data; providing a computing resource budget to each of the plurality of users based on the resource pricing information; generating utilization recommendations for each of the plurality of users based on the resource pricing information and the computing resource budget; receiving resource requests from one or more of the plurality of users in response to the utilization recommendations; and allocating the computing resources to the plurality of users based on the resource requests.

An apparatus for resource allocation is described. One or more aspects of the apparatus include a utilization data component configured to generated utilization data for computing resources shared by a plurality of users; a pricing agent configured to identify resource pricing information based on a reinforcement learning model; and a resource allocation component configured to allocate the computing resources to the plurality of users based on the resource pricing information.

### BRIEF DESCRIPTION OF THE DRAWINGS

FIG. 1 shows an example of a machine learning system according to aspects of the present disclosure.

FIG. 2 shows an example of resource allocation according to aspects of the present disclosure.

FIG. 3 shows an example of a machine learning apparatus according to aspects of the present disclosure.

FIG. 4 shows an example of a process for generating utilization recommendations according to aspects of the present disclosure.

FIG. 5 shows an example of a process for resource pricing according to aspects of the present disclosure.

FIG. 6 shows an example of a process for utilization recommendation according to aspects of the present disclosure.

FIG. 7 shows an example of a process for updating a machine learning model according to aspects of the present disclosure.

### DETAILED DESCRIPTION

The present disclosure provides systems and methods for resource allocation that may receive utilization data for computing resources shared by a plurality of users, update a pricing agent using a reinforcement learning model based on the utilization data, identify resource pricing information using the pricing agent, and allocate the computing resources to the plurality of users based on the resource pricing information.

Resource allocation is a task in computer networking that determines how many of the shared resources should be provided to each network node. Resources may be allocated on a predetermined basis, where users of the computer network are free to use or not use the resources as needed. However, this allocation system is inefficient, as the users are not incentivized to de-allocate unneeded resources, and when the resources are allocated to users in exchange for payment, a user that has been charged for the use of idle resources may not be aware that they are incurring costs.

To more efficiently allocate computing resources, an embodiment of the present disclosure includes a machine learning model that collects utilization data and be trained based on the collected utilization data. The machine learning model identifies resource pricing information, and allocate the resources to the users based on the resource pricing information.

Accordingly, at least one embodiment of the present disclosure learns about resource utilization in a computer network, and then efficiently allocates resources to users of the network based on the knowledge of resource utilization and resource pricing, so that the resources are intelligently allocated both according to need and an ability to pay for them.

At least one embodiment of the present disclosure may be used in a resource allocation context. For example, a set of users has access to a pool of shared computing resources (such as software, hardware, software that employs distributed hardware, cloud computing resources, etc.), and an embodiment of the present disclosure updates a neural-network based pricing agent via a training component using a reinforcement learning model based on utilization data. By considering price in a training process, the pricing agent learns over time how to set a price for a given period of time, and by allocating the computing resources to the set of users based on the pricing information, computing resource utilization among the set of users is maximized.

The term “utilization data” refers to data that may include identifications for one or more users, identifications of one or more groups a given user is associated with, the number and kinds of resources that are or were allocated to each of the users over a certain time period, and/or whether an allocated resource was used by a user over a certain time period. The utilization data may be organized as user blocks.

The term “computing resources” refers to a resource that is shared among users, such as software, hardware, and/or software that employs distributed hardware. In some examples, the computing resources are graphical processing units (GPUs), and their processing power may be shared and utilized by one or more user devices via a cloud network.

The term “pricing agent” refers to a component that includes one or more neural networks that are updated using a reinforcement learning model based on the utilization data. By considering the utilization data in the training process, the pricing agent learns over time how to set optimal resource pricing information that results in maximum computing resource utilization for a given period of time.

The term “resource pricing information” refers to “prices” calculated by the pricing agent to maximize computing resource utilization among a group of users. The term “price” indicates that users may purchase the computing resources according to a computing resource budget that measures resource pricing information against available credit in the budget. The budget may directly correspond to a non-periodic payment into a user account balance (where, for example, each credit in the user account equates to having a credit available in the computing resource budget), or may correspond to a budget that is determined on a periodic basis (where, for example, a user is given a budget of ten credits per month), or may correspond to another appropriate form of budgeting. The resource pricing information corresponds to these credits, and a user's budget is debited when a computing resource is allocated to the user.

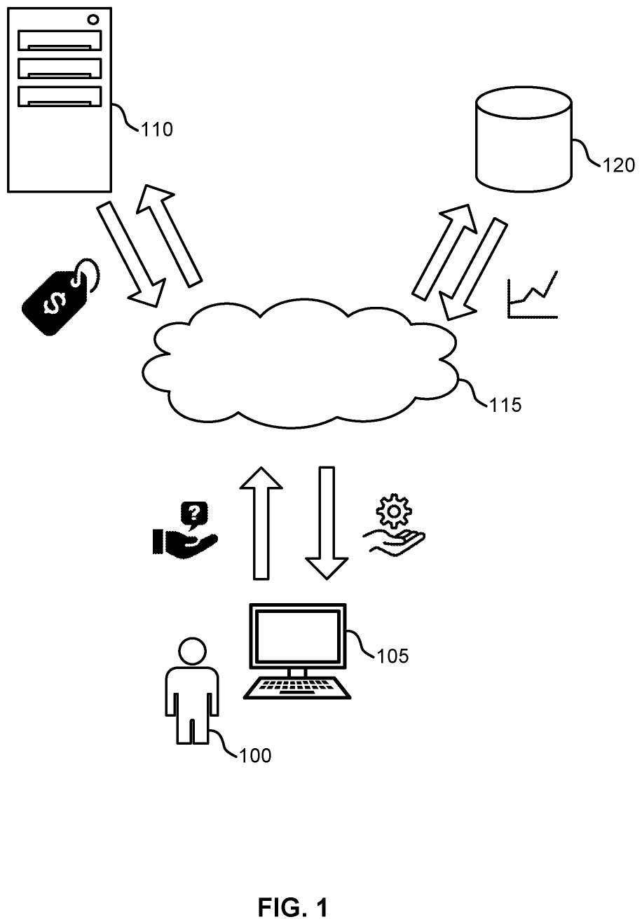

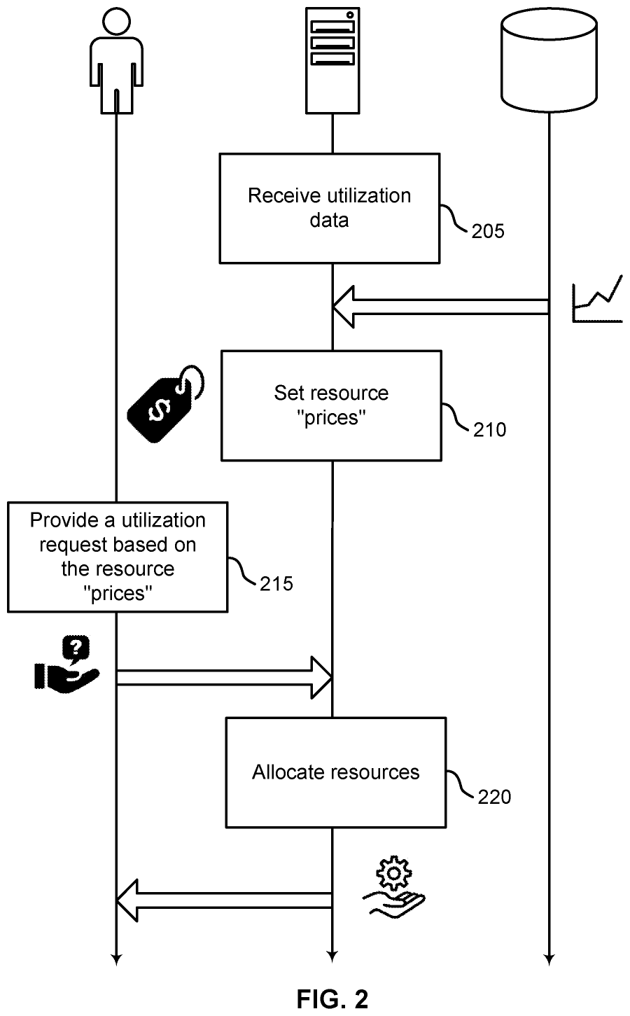

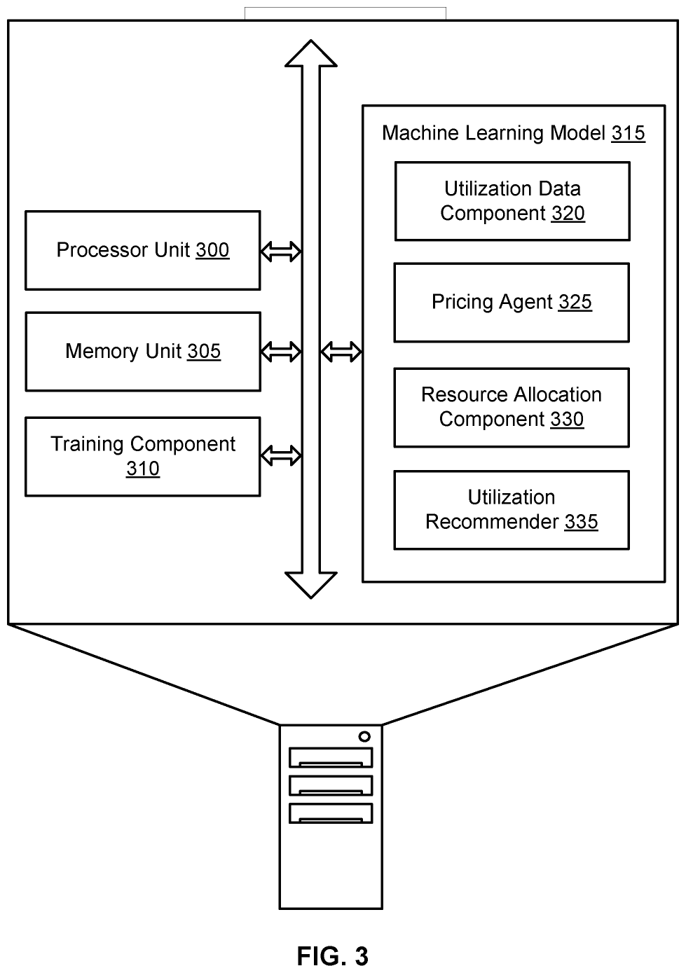

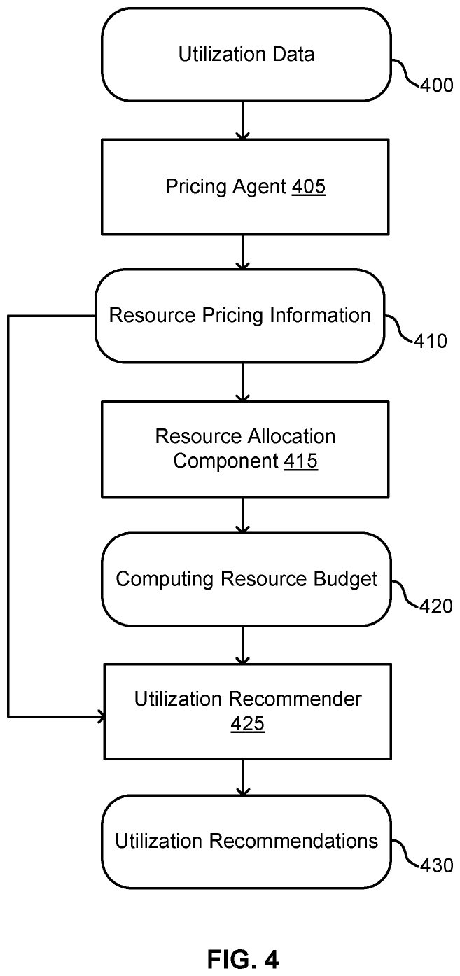

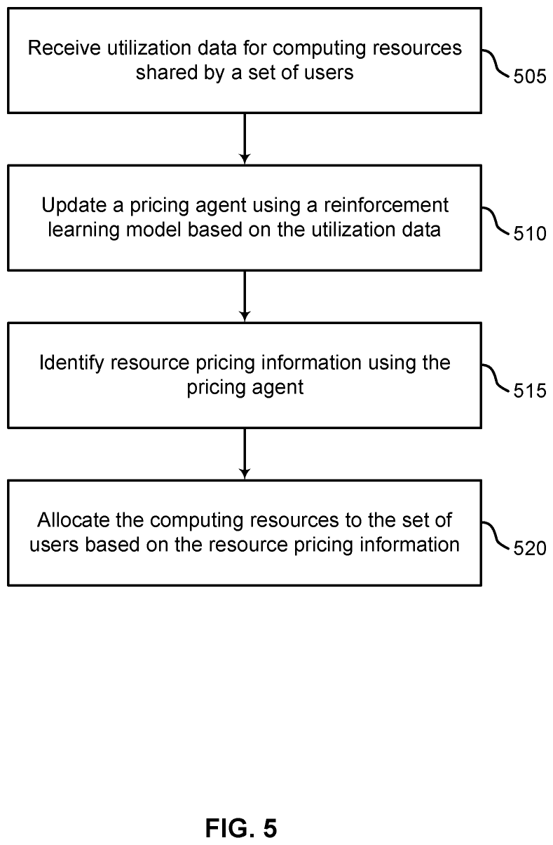

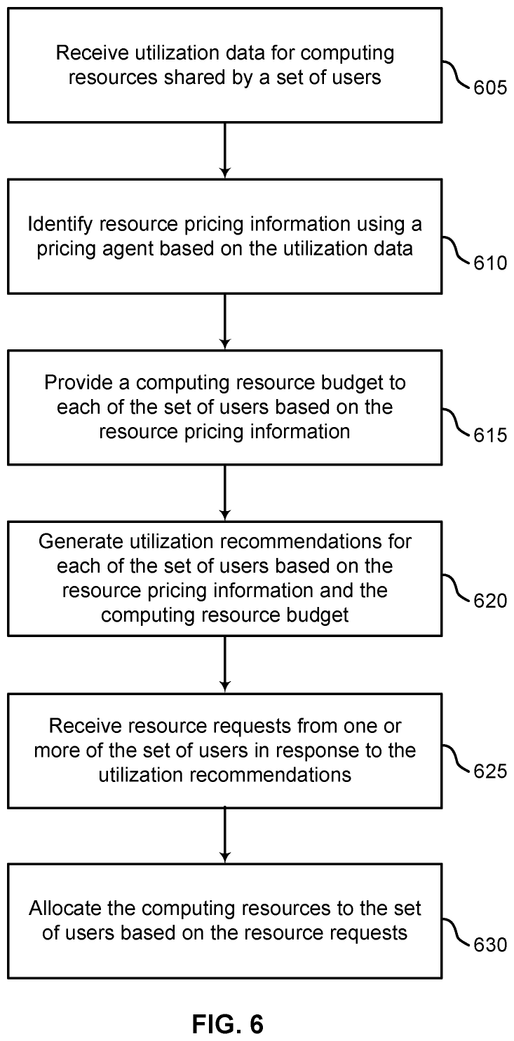

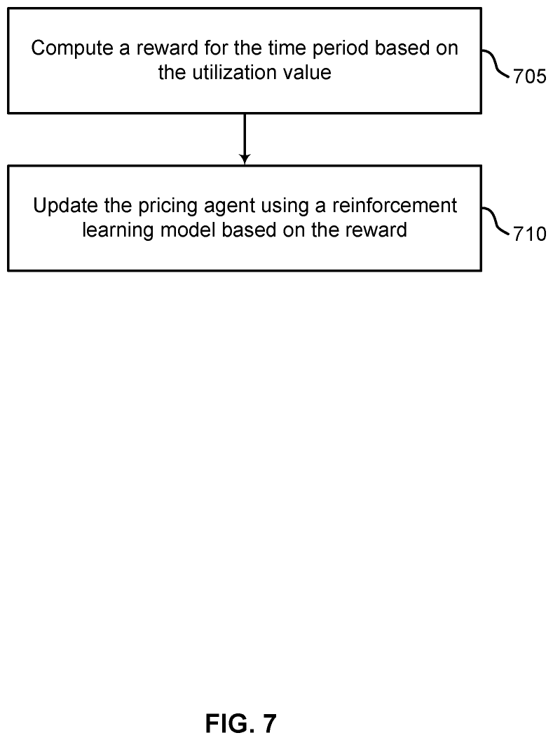

An example application of the inventive concept in the resource allocation context is provided with reference to FIGS. 1-2. Details regarding the architecture of an example machine learning apparatus are provided with reference to FIGS. 3-4. Examples of a process for resource allocation are provided with reference to FIG. 5. Examples of a process for utilization recommendation are provided with reference to FIGS. 6-7.

### Resource Allocation System

FIG. 1 shows an example of a machine learning system according to aspects of the present disclosure. The example shown includes user 100, user device 105, machine learning apparatus 110, cloud 115, and database 120.

Referring to FIG. 1, machine learning apparatus 110 may receive utilization data from database 120 via cloud 115. Machine learning apparatus 110 may set computing resource prices based on the utilization data and may provide the computing resource prices to user 100 via user device 105 and cloud 115. Machine learning apparatus 110 may receive a utilization request based on the computing resource prices from user 100 via user device 105 and cloud 115, and may similarly provide user 100 with the computing resources.

User device 105 may be a personal computer, laptop computer, mainframe computer, palmtop computer, personal assistant, mobile device, or any other suitable processing apparatus. In some examples, user device 105 includes software that communicates with machine learning apparatus 110, cloud 115, and database 120 to receive and display utilization data, computing resource pricing information, computing resource budgets, utilization requests, and/or computing resource allocation notifications. In some examples, when machine learning apparatus 110 allocates the computing resources to user 100, user device 105 is provided with additional functionality and/or processing power. For example, the computing resource may be a GPU, and when machine learning apparatus 110 allocates the GPU to user 100, user device 105 may use the GPU in processing tasks via a mobile or cloud-based software application.

Machine learning apparatus 110 may include a computer implemented network that includes one or more neural networks. Machine learning apparatus 110 may also include one or more processors, a memory subsystem, a communication interface, an I/O interface, one or more user interface components, and a bus. Additionally, machine learning apparatus 110 may communicate with user device 105 and database 120 via cloud 115.

In some cases, machine learning apparatus 110 is implemented on a server. A server provides one or more functions to users 100 linked by way of one or more of the various networks. In some cases, the server includes a single microprocessor board, which includes a microprocessor responsible for controlling all aspects of the server. In some cases, a server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Further detail regarding the architecture of machine learning apparatus 110 is provided with reference to FIGS. 3-4. Further detail regarding a resource allocation process is provided with reference to FIG. 5. Further detail regarding a process for utilization recommendation is provided with reference to FIGS. 6-7.

A cloud such as cloud 115 is a computer network configured to provide on-demand availability of computer system resources, such as data storage and computing power. In some examples, cloud 115 provides resources without active management by user 100. For example, the computing resources may be included in cloud 115. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

A database such as database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, user 100 interacts with the database controller. In other cases, the database controller may operate automatically without user interaction.

FIG. 2 shows an example of resource allocation according to aspects of the present disclosure. Referring to FIG. 2, a set of users has access to a pool of shared computing resources (such as software, hardware, and/or software that employs distributed hardware), and a machine learning apparatus sets computing resource prices based on utilization data. By allocating the computing resources to the set of users based on the pricing information, computing resource utilization among the set of users is maximized.

At operation 205, the system receives utilization data. In some cases, the operations of this step refer to, or may be performed by, a machine learning apparatus as described with reference to FIG. 1. For example, the machine learning apparatus may receive utilization data as described with reference to FIG. 5.

At operation 210, the system sets resource “prices”. In some cases, the operations of this step refer to, or may be performed by, a machine learning apparatus as described with reference to FIG. 1. For example, the machine learning apparatus may identify resource pricing information as described with reference to FIG. 5. The term “price” indicates that users may purchase the computing resources according to a computing resource budget that measures resource pricing information against available credit in the budget.

At operation 215, the user provides a utilization request based on the resource “prices”. In some cases, the operations of this step refer to, or may be performed by, a user as described with reference to FIG. 1. For example, the user may provide a utilization request as described with reference to FIG. 6.

At operation 220, the system allocates resources. In some cases, the operations of this step refer to, or may be performed by, a machine learning apparatus as described with reference to FIG. 1. For example, the machine learning apparatus may allocate computing resources as described with reference to FIGS. 5-6.

### Architecture

An apparatus for resource allocation is described. One or more aspects of the apparatus include a utilization data component configured to generated utilization data for computing resources shared by a plurality of users; a pricing agent configured to identify resource pricing information based on a reinforcement learning model; and a resource allocation component configured to allocate the computing resources to the plurality of users based on the resource pricing information.

In some aspects, a utilization recommender configured to generate utilization recommendations for the plurality of users based on the reinforcement learning model. In some aspects, the utilization data component is configured to generating a time series of resource utilization for the plurality of users based on the utilization data. In some aspects, the resource allocation component is configured to provide a resource budget to each of the plurality of users, and to receive resource requests, wherein the allocation of the computing resources is based on the resource budget and the resource requests.

In some aspects, the pricing agent is configured to generate resource prices for each of a plurality of time periods, wherein the allocation of the computing resources is based on the resource prices. In some aspects, a training component configured to update the pricing agent using a reinforcement learning model.

FIG. 3 shows an example of a machine learning apparatus according to aspects of the present disclosure. The example shown includes processor unit 300, memory unit 305, training component 310, and machine learning model 315.

Processor unit 300 includes one or more processors. A processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor unit 300 is configured to operate a memory array using a memory controller. In other cases, a memory controller is integrated into processor unit 300. In some cases, processor unit 300 is configured to execute computer-readable instructions stored in memory unit 305 to perform various functions. In some embodiments, processor unit 300 includes special purpose components for modem processing, baseband processing, digital signal processing, or transmission processing.

Memory unit 305 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor of processor unit 300 to perform various functions described herein. In some cases, memory unit 305 contains, among other things, a basic input/output system (BIOS) which controls basic hardware or software operation such as the interaction with peripheral components or devices. In some cases, memory unit 305 includes a memory controller that operates memory cells of memory unit 305. For example, the memory controller may include a row decoder, column decoder, or both. In some cases, memory cells within memory unit 305 store information in the form of a logical state.

Machine learning model 320 may include one or more artificial neural networks (ANNs). An ANN is a hardware or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the neural network. Hidden representations are machine-readable data representations of an input that are learned from a neural network's hidden layers and are produced by the output layer. As the neural network's understanding of the input improves as it is trained, the hidden representation is progressively differentiated from earlier iterations.

During a training process of an ANN, the node weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

The term “loss function” refers to a function that impacts how a machine learning model is trained in a supervised learning model. Specifically, during each training iteration, the output of the model is compared to the known annotation information in the training data. The loss function provides a value for how close the predicted annotation data is to the actual annotation data. After computing the loss function, the parameters of the model are updated accordingly and a new set of predictions are made during the next iteration.

In one aspect, machine learning model 315 includes utilization data component 320, pricing agent 325, resource allocation component 330, and utilization recommender 335. Each of utilization data component 320, pricing agent 325, resource allocation component 330, and utilization recommender 335 may include one or more ANNs.

According to some aspects, utilization data component 320 receives utilization data for computing resources shared by a set of users. In some examples, utilization data component 320 generates a time series of resource utilization for the set of users based on the utilization data. In some examples, a reinforcement learning model is based on the time series. In some examples, utilization data component 320 identifies a utilization value for a time period based on the utilization data. In some examples, utilization data component 320 predicts a utilization for a time period based on the reinforcement learning model. In some aspects, the computing resources include GPUs configured for machine learning.

According to some aspects, pricing agent 325 identifies resource pricing information. In some examples, pricing agent 325 identifies the resource pricing information based on the utilization data. In some examples, pricing agent 325 identifies the resource pricing information based on a reinforcement learning model. In some examples, pricing agent 325 selects a resource price for a time period from a set of candidate resource prices, where the pricing information includes the resource price. In some aspects, pricing agent 325 is configured to generate resource prices for each of a set of time periods, where the allocation of the computing resources is based on the resource prices. Pricing agent 325 is an example of, or includes aspects of, the corresponding element described with reference to FIG. 4.

According to some aspects, resource allocation component 330 allocates the computing resources to the set of users based on the resource pricing information. In some examples, resource allocation component 330 allocates a resource budget to a user of the set of users. In some examples, resource allocation component 330 receives a resource request from a user. In some examples, resource allocation component 330 allocates a portion of the computing resources to the user based on the request. In some examples, resource allocation component 330 deducts a price value from the resource budget based on the resource pricing information. In some examples, resource allocation component 330 allocates a resource budget to a user of the set of users. In some examples, resource allocation component 330 receives a resource request from a user. In some examples, resource allocation component 330 determines that the resource request exceeds a remaining amount of the resource budget. In some examples, resource allocation component 330 refrains from providing the computing resources to the user based on the determination.

According to some aspects, resource allocation component 330 provides a computing resource budget to each of the set of users based on the resource pricing information. In some examples, resource allocation component 330 receives resource requests from one or more of the set of users in response to the utilization recommendations. In some examples, resource allocation component 330 allocates the computing resources to the set of users based on the resource requests. In some examples, resource allocation component 330 deducts a price value from the resource budget of a user based on the allocation of the computing resources and the resource pricing information. In some examples, resource allocation component 330 determines that the resource request exceeds a remaining amount of a resource budget of a user. In some examples, resource allocation component 330 refrains from providing the computing resources to the user based on the determination. Resource allocation component 330 is an example of, or includes aspects of, the corresponding element described with reference to FIG. 4.

According to some aspects, utilization recommender 335 generates a utilization recommendation for a user based on the predicted utilization. According to some aspects, utilization recommender 335 generates utilization recommendations for each user of the set of users based on the resource pricing information and the computing resource budget. In some aspects, utilization recommender 335 is configured to generate utilization recommendations for the set of users based on the reinforcement learning model. Utilization recommender 335 is an example of, or includes aspects of, the corresponding element described with reference to FIG. 4.

According to some aspects, training component 310 updates pricing agent 325 using a reinforcement learning model based on the utilization data. In some examples, training component 310 computes a reward for the time period based on the utilization value, where the reinforcement learning model is based on the reward.

According to some aspects, training component 310 updates pricing agent 325 based on the time series. In some examples, training component 310 computes a reward for the time period based on the utilization value. In some examples, training component 310 updates the pricing agent 325 using a reinforcement learning model based on the reward.

FIG. 4 shows an example of a process for generating utilization recommendations 430 according to aspects of the present disclosure. The example shown includes utilization data 400, pricing agent 405, resource pricing information 410, resource allocation component 415, computing resource budget 420, utilization recommender 425, and utilization recommendations 430.

Pricing agent 405 is an example of, or includes aspects of, the corresponding element described with reference to FIG. 3. Resource allocation component 415 is an example of, or includes aspects of, the corresponding element described with reference to FIG. 3. Utilization recommender 425 is an example of, or includes aspects of, the corresponding element described with reference to FIG. 3.

Referring to FIG. 4, in an embodiment, pricing agent 405 receives utilization data 400 as input and outputs resource pricing information 410. Resource allocation component 415 receives resource pricing information 410 as input and outputs computing resource budget 420. Utilization recommender 425 receives resource pricing information 410 and computing resource budgets as inputs and outputs utilization recommendations 430.

### Resource Pricing

A method for resource allocation is described. One or more aspects of the method include receiving utilization data for computing resources shared by a plurality of users; updating a pricing agent using a reinforcement learning model based on the utilization data; identifying resource pricing information using the pricing agent; and allocating the computing resources to the plurality of users based on the resource pricing information.

Some examples of the method and apparatus further include generating a time series of resource utilization for the plurality of users based on the utilization data, wherein the reinforcement learning model is based on the time series. Some examples of the method and apparatus further include identifying a utilization value for a time period based on the utilization data. Some examples further include computing a reward for the time period based on the utilization value, wherein the reinforcement learning model is based on the reward.

Some examples of the method and apparatus further include selecting a resource price for a time period from a plurality of candidate resource prices, wherein the pricing information comprises the resource price. Some examples of the method and apparatus further include allocating a resource budget to a user of the plurality of users. Some examples further include receiving a resource request from a user. Some examples further include allocating a portion of the computing resources to the user based on the request. Some examples further include deducting a price value from the resource budget based on the resource pricing information.

Some examples of the method and apparatus further include allocating a resource budget to a user of the plurality of users. Some examples further include receiving a resource request from a user. Some examples further include determining that the resource request exceeds a remaining amount of the resource budget. Some examples further include refraining from providing the computing resources to the user based on the determination.

Some examples of the method and apparatus further include predicting a utilization for a time period based on the reinforcement learning model. Some examples further include generating a utilization recommendation for a user based on the predicted utilization. In some aspects, the computing resources comprise GPUs configured for machine learning.

FIG. 5 shows an example of resource pricing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 5, at least one embodiment of the present disclosure may be used in a resource allocation context. For example, a set of users has access to a pool of shared computing resources (such as software, hardware, and/or software that employs distributed hardware), and an embodiment of the present disclosure updates a neural-network based pricing agent via a training component using a reinforcement learning model based on utilization data. By considering the utilization data in the training process, the pricing agent learns over time how to set an optimal price for a given period of time, and by allocating the computing resources to the set of users based on the optimal pricing information, computing resource utilization among the set of users is maximized.

At operation 505, the system receives utilization data for computing resources shared by a set of users. In some cases, the operations of this step refer to, or may be performed by, a utilization data component as described with reference to FIG. 3.

For example, the utilization data component receives utilization data from a database such as the database described with reference to FIG. 1. The utilization data may include identifications for one or more users, identifications of one or more groups a given user is associated with, the number and kinds of resources that are or were allocated to each of the users over a certain time period, and whether an allocated resource was used by a user over a certain time period.

The utilization data may thus be organized as user blocks. A user block may include congruent days, and a utilization value for a particular allocated resource on a particular day is represented as a value ∈[0,100], where 0 represents that the user has not used an allocated resource at all.

The utilization data component may then determine utilized resources (i.e., utilization multiplied by resources) yᵢₜ at a given period t allocated to a user i at a block b at day t of the block b by generating a time-series statistical model:

$${y}_{it} = {θ}_{1} + {θ}_{2} {y}_{ib ( t - 1 )} + {θ}_{3} \frac{1}{t - 2} {\sum }_{{t}^{′}}^{t - 2} {y}_{{ibt}^{′}} + {θ}_{4} \vert {y}_{ib ( t - 1 )} - {y}_{ib ( t - 2 )} \vert + {θ}_{5} {\sum }_{{b}^{′}}^{b - 1} {\sum }_{{t}^{′}}^{T ( {b}^{′} )} {y}_{{ib}^{′} {t}^{′}} + {θ}_{6} t + {θ}_{7 : 14}^{T} + {ϵ}_{ibt} \qquad ( 1 )$$

where T(b′) denotes the total number of days in block b′ of user i, and mᵢ is an n-dimensional binary vector that indicates group membership of user i (given a global intercept θ₁, parameter identification implies that the dimensionality of mᵢ equals the total number of groups minus one), and ϵ_{ibt} is the model's error term.

Thus, the parameters θ=(θ₁, θ₂, θ₃, θ₄, θ₅, θ₆, θ_{7:14}) correspond to (excluding the intercept θ₁) a lagged response, a mean lagged response in the block excluding the response from t−1, an absolute difference in the response of the two last periods, a total resource allocation in past blocks, an index of a period in the block, and a group membership.

At operation 510, the system updates a pricing agent using a reinforcement learning model based on the utilization data. In some cases, the operations of this step refer to, or may be performed by, a training component as described with reference to FIG. 3.

Reinforcement learning is one of three basic machine learning paradigms, alongside supervised learning and unsupervised learning. Specifically, reinforcement learning relates to how software agents make decisions in order to maximize a reward. The decision making model may be referred to as a policy. This type of learning differs from supervised learning in that labelled training data is not needed, and errors need not be explicitly corrected. Instead, reinforcement learning balances exploration of unknown options and exploitation of existing knowledge. In some cases, the reinforcement learning environment is stated in the form of a Markov decision process (MDP) based on a set of environment and agent states, a set of actions of the agent, a probability of a state transition under an action, and a reward for transitioning from one state to another during the action.

Furthermore, many reinforcement learning algorithms utilize dynamic programming techniques. However, one difference between reinforcement learning and other dynamic programming methods is that reinforcement learning does not require an exact mathematical model of the MDP. Therefore, reinforcement learning models may be used for large MDPs where exact methods are impractical.

In some embodiments, the training component computes a reward for the time period based on the utilization value, where the reinforcement learning model is based on the reward. In some embodiments, the training component updates the pricing agent based on the time series. In some examples, training component 310 computes a reward for the time period based on the utilization value. In some examples, training component 310 updates the pricing agent 325 using a reinforcement learning model based on the reward.

In some examples, the training component computes a reward for the time period based on the utilization value, where the reinforcement learning model is based on the reward. In some example, the training component updates the pricing agent based on the time series. In some examples, the training component computes a reward for the time period based on the utilization value. In some examples, the training component updates the pricing agent using a reinforcement learning model based on the reward.

For example, at a given period t∈[T], the training component uses data provided by the pricing agent to train the pricing agent to calculate a reward by setting a price such that resource utilization in the period is maximized, where the utilization of resources RESs at period t among N users is:

$${utilization}_{t} = \frac{{\sum }_{i = 1}^{N} {URES}_{it}}{{\sum }_{i = 1}^{N} {DRES}_{it}} \qquad ( 2 )$$

where URES represents utilized resources where DRES represents demanded resources. As URESᵢₜ≤DRESᵢₜ, it follows that utilizationₜ ∈[0, 1].

At operation 515, the system identifies resource pricing information using the pricing agent. For example, the system may set resource pricing information to determine a reasonable price for computing assets. In some cases, the operations of this step refer to, or may be performed by, a pricing agent as described with reference to FIGS. 3 and 4. The term “resource pricing information” refers to “prices” calculated by the pricing agent to maximize computing resource utilization among a group of users

For example, at a period t, the pricing agent may use a pricing model:

$${X}_{t} = {\{ ( {price}_{τ} , {price}_{τ}^{2} , \frac{1}{N} {\sum }_{i = 1}^{N} {budget}_{i τ} , \frac{1}{N} {\sum }_{i = 1}^{N} {DRES}_{it} {DRES}_{i ( t - 1 )} \}}_{τ = 1}^{t - 1} \qquad ( 3 )$$

$${y}_{t} = {\{ {utilization}_{τ} \}}_{τ = 1}^{t - 1} \qquad ( 4 )$$

where Xₜ are covariates and yₜ are corresponding response variables. In an embodiment, the pricing agent uses a Linear Regression pricing model. In this case, the term price_{τ}² prevents the pricing agent from predicting a best price as either 0 or infinity.

Then, at each period t∈[T], the pricing agent considers a set of candidate prices CPₜ:

$${CP}_{t} = \{ ESN [ 0.8 \cdot {min}_{τ ∈ [ t - 1 ]} {price}_{τ} , 1.2 \cdot {max}_{τ ∈ [ t - 1 ]} {price}_{τ} ] \} \qquad ( 5 )$$

where ESN represents 50 evenly spaced numbers in the interval that follows ESN in equation (5).

Given a computing resource budget at the beginning of period t and demanded resources at period t−1, the pricing agent considers a covariate vector, predicts a corresponding utilization for each price in the set of candidate prices CPₜ, and chooses or selects resource pricing information from the set of candidate prices CPₜ, that corresponds to a highest predicted utilizationₜ. The system may calculate a computing resource budget as described with reference to FIG. 6.

At operation 520, the system allocates the computing resources to the set of users based on the resource pricing information. In some cases, the operations of this step refer to, or may be performed by, a resource allocation component as described with reference to FIGS. 3 and 4. For example, the resource allocation component may allocate a computing resource to a user if the user has a computing resource budget that is greater than the resource pricing information. In some cases, the resource allocation component may allocate a computing resource to a user by providing the resource directly to a user device. In some cases, the resource allocation component may allocate a computing device to a user by providing the user or a user device with access to the computing resource (for example, either directly, by provisioning or updating user access information such that a user device associated with the user may use the computing resource, or indirectly, by providing access information to cloud- or mobile-based software that uses the computing resource). For example, the computing resource may be one or more graphical processing units (GPUs) configured for machine learning, and the resource allocation component may allocate the GPUs to the user by instructing a central server to enable functionality associated with the GPUs in software that is installed or is accessible by a user device. In another example, the computing resource may be one or more central processing units (CPUs), storage devices, and the like.

### Utilization Recommendation

A method for utilization recommendation is described. One or more aspects of the method include receiving utilization data for computing resources shared by a plurality of users; identifying resource pricing information using a pricing agent based on the utilization data; providing a computing resource budget to each of the plurality of users based on the resource pricing information; generating utilization recommendations for each of the plurality of users based on the resource pricing information and the computing resource budget; receiving resource requests from one or more of the plurality of users in response to the utilization recommendations; and allocating the computing resources to the plurality of users based on the resource requests.

Some examples of the method and apparatus further include generating a time series of resource utilization for the plurality of users based on the utilization data. Some examples further include updating the pricing agent is based on the time series. Some examples of the method and apparatus further include identifying a utilization value for a time period based on the utilization data. Some examples further include computing a reward for the time period based on the utilization value. Some examples further include updating the pricing agent using a reinforcement learning model based on the reward.

Some examples of the method and apparatus further include selecting a resource price for a time period from a plurality of candidate resource prices, wherein the pricing information comprises the resource price. Some examples of the method and apparatus further include deducting a price value from the resource budget of a user based on the allocation of the computing resources and the resource pricing information.

Some examples of the method and apparatus further include determining that the resource request exceeds a remaining amount of a resource budget of a user. Some examples further include refraining from providing the computing resources to the user based on the determination.

FIG. 6 shows an example of utilization recommendation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system receives utilization data for computing resources shared by a set of users. In some cases, the operations of this step refer to, or may be performed by, a utilization data component as described with reference to FIG. 3. For example, the utilization data component may receive utilization data as described with reference to FIG. 5.

At operation 610, the system identifies resource pricing information using a pricing agent based on the utilization data. In some cases, the operations of this step refer to, or may be performed by, a pricing agent as described with reference to FIGS. 3 and 4. For example, the pricing agent may identify resource pricing information as described with reference to FIG. 5.

At operation 615, the system provides a computing resource budget to each of the set of users based on the resource pricing information. In some cases, the operations of this step refer to, or may be performed by, a resource allocation component as described with reference to FIGS. 3 and 4.

For example, each user i in the set of users may have a computing resource budget B for use in resource allocation. The budget may directly correspond to a non-periodic payment into a user account balance (where, for example, each credit in the user account equates to having a credit available in the computing resource budget), or may correspond to a budget that is determined on a periodic basis (where, for example, a user is given a budget of ten credits per month), or may correspond to another appropriate form of budgeting. The resource pricing information corresponds to these credits, and a user's budget is debited (e.g., a computing budget resource of a user is decreased by priceₜ×DRESᵢₜ) when a computing resource is allocated to the user. The resource allocation component may track the computing resource budget of each user and provide the computing resource budget to the user via a user device.

At operation 620, the system generates utilization recommendations for each of the set of users based on the resource pricing information and the computing resource budget. In some cases, the operations of this step refer to, or may be performed by, a utilization recommender as described with reference to FIGS. 3 and 4.

For example, the utilization recommender may generate utilization recommendations UR for a user i at period t as a vector of dimensionality (1+max resources a user can ask for):

$${UR}_{itj} = \{ \begin{matrix}100 & if j \leq {pred\_y}_{it} \\ 100 \cdot \frac{{y}_{it}}{j} & if j > {pred\_y}_{it}\end{matrix} \qquad ( 6 )$$

where j∈{0, maximum computing resources available to a user} and pred_yᵢₜ is the predicted computing resource utilization by a user i at a time t.

In some embodiments, pred_yᵢₜ is calculated to be equal to yᵢₜ. In some embodiments, pred_yᵢₜ is calculated to be yᵢₜ plus a permanent heterogeneity variable ηᵢ distributed as ηᵢ˜ [symbol] (0,1).

The utilization recommender may provide each utilization recommendation to each user in the set of users via a user device.

At operation 625, the system receives resource requests from one or more of the set of users in response to the utilization recommendations. In some cases, the operations of this step refer to, or may be performed by, a resource allocation component as described with reference to FIGS. 3 and 4.

For example, a user may request to be allocated computing resources through a user device. The user request may be based on whether the user can “afford” the computing resources given their budget. The resource allocation component may calculate the affordability of the computing resources and provide that information to the user i:

AFFORDᵢₜ={j∈{0, max resources}:j·priceₜ≤bugetᵢₜ} (7)

In some cases, the resource allocation component may calculate a probability PROB that a given user will request j computing resources:

$$PROB = \frac{exp ( {pred\_y}_{itj} - \frac{1}{2} \cdot j \cdot {price}_{t} )}{{\sum }_{k ∈ {AFFORD}_{it}} exp ( {pred\_y}_{itk} - \frac{1}{2} \cdot k \cdot {price}_{t} )} \qquad ( 8 )$$

where

$${pred\_y}_{itj} = j \cdot \frac{{UR}_{itj}}{100}$$

and the ½ is a coefficient that is instead an estimated parameter in some embodiments. The resource allocation component may use the probability that a user will request computing resources to anticipate the user resource request.

At operation 630, the system allocates the computing resources to the set of users based on the resource requests. In some cases, the operations of this step refer to, or may be performed by, a resource allocation component as described with reference to FIGS. 3 and 4. For example, given a resource request d from a user i at time t, the resource allocation component allocates resources to the user according to:

$$allocated resources = d \cdot {[ \frac{{UR}_{itj} + {ϵ}_{it}}{100} ]}_{0 , 1} \qquad ( 9 )$$

where ϵᵢₜ˜Uniform(−10, 10) and

$${[ x ]}_{0.1} = \{ \begin{matrix}x if x ∈ [ 0 , 1 ] \\ 0 if x \leq 0 \\ 1 if x \geq 1\end{matrix} \qquad ( 10 )$$

For example, the resource allocation component may allocate the computing resources to the set of users as described with reference to FIG. 5.

FIG. 7 shows an example of updating a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system computes a reward for the time period based on the utilization value. In some cases, the operations of this step refer to, or may be performed by, a training component as described with reference to FIG. 3. For example, the training component may compute a reward as described with reference to FIG. 5.

At operation 710, the system updates the pricing agent using a reinforcement learning model based on the reward. In some cases, the operations of this step refer to, or may be performed by, a training component as described with reference to FIG. 3. For example, the training component may update the pricing agent as described with reference to FIG. 5.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
receiving utilization data for computing resources shared by a plurality of users;
updating a pricing agent using a reinforcement learning model based on the utilization data;
identifying resource pricing information using the pricing agent; and
allocating the computing resources to the plurality of users based on the resource pricing information.

2. The method of claim 1, further comprising:
generating a time series of resource utilization for the plurality of users based on the utilization data, wherein the reinforcement learning model is based on the time series.

3. The method of claim 1, wherein:
identifying a utilization value for a time period based on the utilization data; and
computing a reward for the time period based on the utilization value, wherein the reinforcement learning model is based on the reward.

4. The method of claim 1, further comprising:
selecting a resource price for a time period from a plurality of candidate resource prices, wherein the pricing information comprises the resource price.

5. The method of claim 1, further comprising:
allocating a resource budget to a user of the plurality of users;
receiving a resource request from a user;
allocating a portion of the computing resources to the user based on the request; and
deducting a price value from the resource budget based on the resource pricing information.

6. The method of claim 1, further comprising:
allocating a resource budget to a user of the plurality of users;
receiving a resource request from a user;
determining that the resource request exceeds a remaining amount of the resource budget; and
refraining from providing the computing resources to the user based on the determination.

7. The method of claim 1, further comprising:
predicting a utilization for a time period based on the reinforcement learning model; and
generating a utilization recommendation for a user based on the predicted utilization.

8. The method of claim 1, wherein:
the computing resources comprise GPUs configured for machine learning.

9. A method comprising:
receiving utilization data for computing resources shared by a plurality of users;
identifying resource pricing information using a pricing agent based on the utilization data;
providing a computing resource budget to each of the plurality of users based on the resource pricing information;
generating utilization recommendations for each of the plurality of users based on the resource pricing information and the computing resource budget;
receiving resource requests from one or more of the plurality of users in response to the utilization recommendations; and
allocating the computing resources to the plurality of users based on the resource requests.

10. The method of claim 9, further comprising:
generating a time series of resource utilization for the plurality of users based on the utilization data; and
updating the pricing agent is based on the time series.

11. The method of claim 9, wherein:
identifying a utilization value for a time period based on the utilization data;
computing a reward for the time period based on the utilization value; and
updating the pricing agent using a reinforcement learning model based on the reward.

12. The method of claim 9, further comprising:
selecting a resource price for a time period from a plurality of candidate resource prices, wherein the pricing information comprises the resource price.

13. The method of claim 9, further comprising:
deducting a price value from the resource budget of a user based on the allocation of the computing resources and the resource pricing information.

14. The method of claim 9, further comprising:
determining that the resource request exceeds a remaining amount of a resource budget of a user; and
refraining from providing the computing resources to the user based on the determination.

15. An apparatus comprising:
a utilization data component configured to generated utilization data for computing resources shared by a plurality of users;
a pricing agent configured to identify resource pricing information based on a reinforcement learning model; and
a resource allocation component configured to allocate the computing resources to the plurality of users based on the resource pricing information.

16. The apparatus of claim 15, further comprising:
a utilization recommender configured to generate utilization recommendations for the plurality of users based on the reinforcement learning model.

17. The apparatus of claim 15, wherein:
the utilization data component is configured to generating a time series of resource utilization for the plurality of users based on the utilization data.

18. The apparatus of claim 15, wherein:
the resource allocation component is configured to provide a resource budget to each of the plurality of users, and to receive resource requests, wherein the allocation of the computing resources is based on the resource budget and the resource requests.

19. The apparatus of claim 15, wherein:
the pricing agent is configured to generate resource prices for each of a plurality of time periods, wherein the allocation of the computing resources is based on the resource prices.

20. The apparatus of claim 15, further comprising:
a training component configured to update the pricing agent using a reinforcement learning model.
